(19) United States
(12) Patent Application Publication
(10) Pub. No.: US 2016/0062646 A1
(43) Pub. Date: Mar. 3, 2016

(54) Device for Displaying a Received User Interface

(71) Applicant: HEWLETT-PACKARD DEVELOPMENT COMPANY, L.P., Houston, TX (US)

(72) Inventors: Syed S. AZAM, Houston, TX (US); Georgios MANDAMADIOTIS, Houston, TX (US); Wen (Phil) Shih CHEN, Taipei (TW)

(21) Appl. No.: 14/781,610

(22) PCT Filed: Apr. 29, 2013
(86) PCT No.: PCT/US2013/038583

§ 371 Date: Oct. 1, 2015

(51) Int. Cl. G06F 3/0488

(52) U.S. Cl. CPC G06F 3/04886

(57) ABSTRACT

An example method in accordance with an aspect of the present disclosure includes receiving, on an interface receiver module of an interface device, a desired user interface from a computing device, and displaying, on a touch-sensitive display of the interface device, the received desired user interface. The method further includes receiving, on the touch-sensitive display of the interface device, a user input related to the desired user interface, and sending, by the interface device, a signal to the computing device indicative of the received user input.

### BACKGROUND

The idea of a user controlling an electronic device remotely or from a distance has become ubiquitous ever since the invention of the remote control for a television. The simple television remote control has served its purpose adequately over the years because a television has limited functionality.

Personal computers with large monitors and especially smart monitors have been gaining popularity, serving as displays for entertainment consumption in the last several years, in essence, smart monitors are a personal computer display with built-in processing and network capability. These devices have become personal computer entertainment stations and provide consumers with access to the Internet, applications, streaming, and stored content such movies, television, music, photographs, etc.

### BRIEF DESCRIPTION OF THE DRAWINGS

The following detailed description references the drawings, in which;

FIG. 1 illustrates a remote control device having a touch-sensitive display for displaying a dynamic user interface received from a computing device according to examples of the present disclosure;

FIG. 2 illustrates a remote control device having a touch-sensitive display displaying a keyboard user interface according to examples of the present disclosure:

FIG. 3 illustrates a remote control device having a touch-sensitive display displaying a media controls user interlace according to examples of the present disclosure;

FIG. 4 illustrates a remote control device having a touch-sensitive display enclosed in a housing according to examples of the present disclosure; and

FIG. 5 illustrates a method for displaying a user Interface received from a computing device on an interface device having a touch-sensitive display according to examples of the present disclosure.

### DETAILED DESCRIPTION

Consumers are facing a usability problem trying to interfaces with personal computer entertainment stations remotely. For example, as personal computer screen sizes grow, users become more remote from the personal computer. To interact with the personal computer, the user may either relocate to be nearer to the personal computer or the user may use a remote control device. For example, a user may use an on-screen keyboard or traditional wired keyboard and mouse if the user is near the personal computer. However, if the user wishes to control the personal computer from a distance, the user may do so with a smart-phone application, a traditional wireless keyboard and/or mouse, or a remote control with keyboard and mouse (e.g., Google™ television remote). However, these solutions may not adequately address all of a user's needs for controlling the personal computer from a distance.

Although remote control devices have been in use for years, a new device is desired to address the complexity of personal computer entertainment stations. A user may desire to use a single device to provide inputs to the personal computer including keyboard input, mouse input, gesture input, media control input, custom application menu input, and the like.

Various embodiments will be described below by referring to several examples of a remote control device having a touch-sensitive display for displaying a dynamic user interface. The sample remote control devices disclosed herein may receive a dynamic user interface from a computing device, display the dynamic user interface on the touch-sensitive display, receive an input from a user on the touch-sensitive display, and send a signal indicative of the received user input to the computing device.

In some implementations, a user may receive an enhanced experience when using a personal computer entertainment station by allowing the user to control the personal computer from a distance. In another example, a user may experience the benefits of using a single control device to control a personal computer entertainment station instead of multiple control devices. In another example, a user may be able to access custom menus and other features that may not be available using traditional control devices. These and other advantages will be apparent from the description that follows.

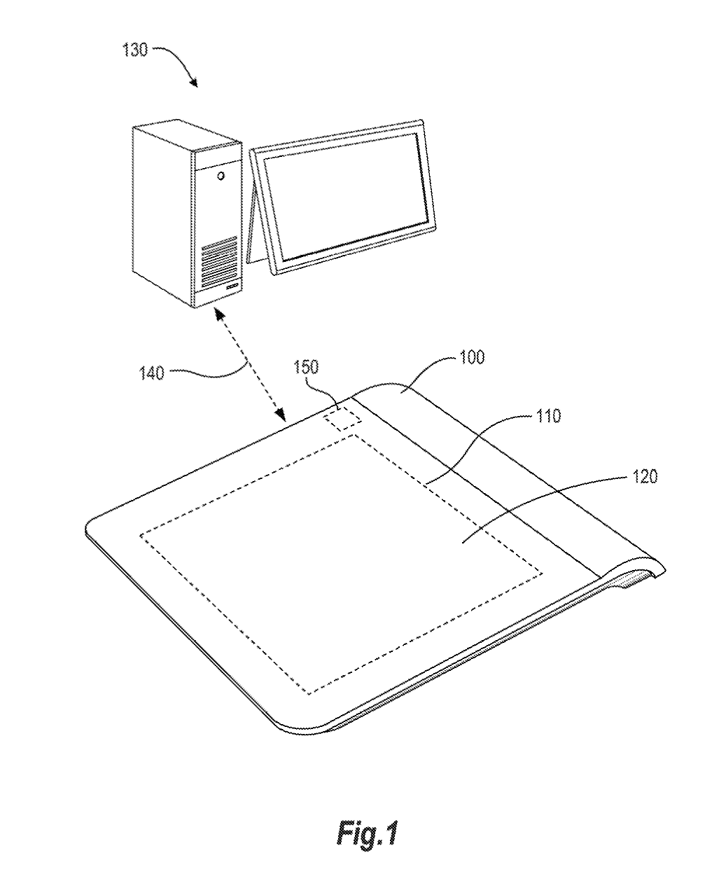

FIG. 1 illustrates a remote control device 100 having a touch-sensitive display 110 for displaying a dynamic user interface 120 received from a computing device 130 according to examples of the present disclosure, it should be understood that the computing system 130 may include any appropriate type of computing device, including for example smartphones, tablets, desktops, laptops, workstations, servers, smart monitors, smart televisions, digital signage, scientific instruments, retail point of sale devices, video walls, or the like.

The remote control device 100 receives the user interface 120 from the computing device 130 via a connection 140 through interface receiver module 150. The connection 140 may utilize wireless transmission methods, including WiFi, radio frequency, Bluetooth, infrared, or any other suitable transmission method.

The user interface 120 may be received through interface receiver module 150, which may be of a type suitable for communicating with the computing device 130 via the connection 140. Upon receiving the user interface 120, the interface receiver module 150 may cause the touch-sensitive display 110 to display the user interface 120. In one example, the interface receiver module 150 may be a hardware module configured to receive and cause to be displayed the user interface 120. In another example, the interface receiver module 150 may comprise instructions to be executed on a processor, as described herein. In one example, the interface receiver module 150 may also receive and transmit a user input from the remote control device 100 to the computing device 130.

The user interface 120 may be dynamic and is determined by the computing device 130 based on the current activity of the computing device 130 and for based on the desired input to be received from the user. For example, if the computing device 130 is playing a movie and is displaying the movie on a monitor or other display of the computing device 130, the computing device 130 may determine that the user interface 120 should display a set of media controls on the touch-sensitive display 110 of the remote control device 110.

Alternatively, if a user of the computing device 130 is browsing the web, a web browser may be displayed on a monitor or other display device of the computing device 130. The user may desire to interact with the web browser by manipulating a mouse pointer/cursor, in this example, the computing device 130 may determine that a user interface 120 for manipulating a mouse pointer/cursor is desired. The computing device 130 may send the user interface 120 for manipulating a mouse pointer/cursor to the remote control device 100 for displaying to the user and for receiving user input.

In this example, the user interface 120 on remote control device 100 may display or include a region for manipulating a mouse pointer/cursor. By moving its finger across the user interface 120 on remote control device 100, the user may cause the mouse pointer/cursor to move in a corresponding manner on the monitor or other display of the computing device 130. As shown in FIG. 1, for example, the user interface 120 may be blank when the user interface 120 is configured to receive mouse pointer/cursor input. The user interface 120 may also display an interface for manipulating the mouse pointer with the user's finger, for example.

In one example, the user interface 120 may support the use of gestures indicative of certain commands. For example, if a user wishes to zoom in or out on the content displayed on the monitor or other display device of computing device 130, the user may place two fingers on the user interface 120 and move them together or apart to zoom in or out respectively. In another example, the user may rotate the content by placing two fingers on the user interface 120 and moving the fingers clock-wise or counter-clock-wise to manipulate the content accordingly. Many other types of gestures may be supported for supporting a variety of commands including navigating and manipulating content and otherwise controlling the computing device 130. The gesture support may be useful when the user interface 120 is displaying a region for manipulating a mouse pointer/cursor and may also be useful with other types of user interfaces displayed on the user interface 120.

ln another example, the computing device 130 may determine that displaying multiple user interfaces on the remote control device 100 simultaneously is desirable. For example, the computing device 130 may cause the touch-sensitive display 110 of remote control device 100 to display a keyboard user interface along with an interface for manipulating the mouse/pointer. Similarly, the computing device 130 may cause the touch-sensitive display 110 of remote control device 100 to display a media controls interface along with an interface for manipulating the mouse/pointer. If a photo editing application is being used by the user, a combination of a mouse/pointer interface, a keyboard interface, and a multi-touch control interface for supporting gestures may be displayed on the user interface 120, for example. Numerous combinations of combined interfaces are possible, and these examples are not limiting.

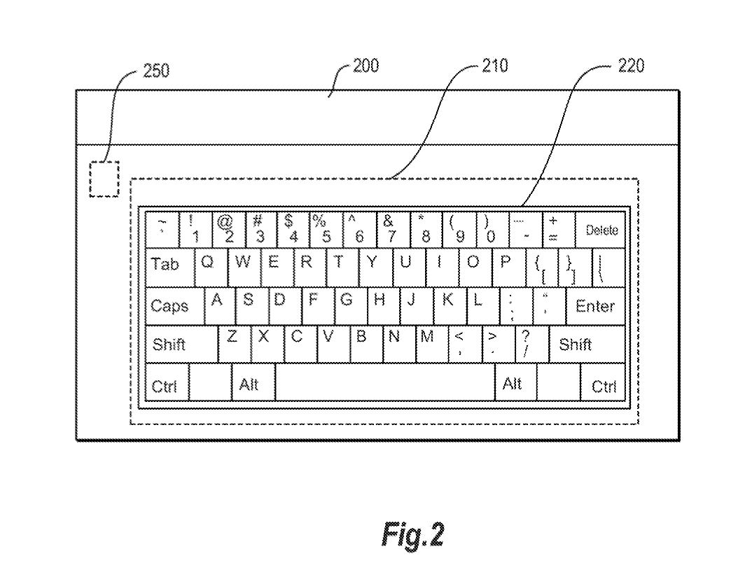

FIG. 2 illustrates a remote control device 200 having touch-sensitive display 210 displaying a keyboard user interface 220 according to examples of the present disclosure. In this example, a computing device, such as the computing device 130 of FIG. 1, determines that a textual input is desired from a user. For example, if a user is prompted to enter a username and password (or any other text), the computing device may cause the keyboard user interface 220 to be displayed on the remote control device 200. In another example, if an email application is being used, the keyboard user interface 220 may appear.

To do this, the computing device may send a keyboard user interface 220 to the remote control device 200 via interface receiver module 250 to enable the user to enter the desired textual input. The user may then enter the desired textual input by touching the touch-sensitive display 210 at a location indicative of the desired input (e.g. touch the “K” key to select the letter “K”). The keyboard user interface 220 shown in FIG. 2 illustrates merely one example of a keyboard layout and should not be seen as limiting. Other keyboard layouts may be used. For example, the keyboard user interface 200 may be customized with multiple languages, in varying sizes (such as for large or small hands), or even with custom keys.

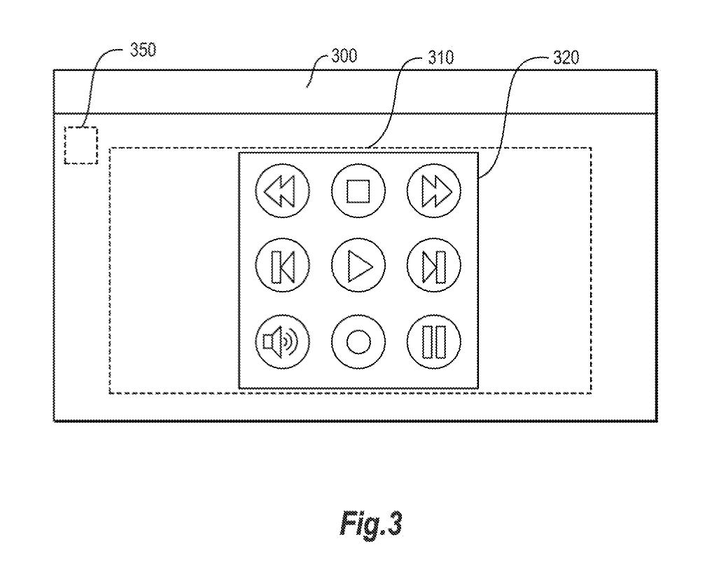

FIG. 3 illustrates a remote control device 300 having a touch-sensitive display 310 displaying a media controls user interface 320 according to examples of the present disclosure. In this example, a computing device, such as the computing device 130 of FIG. 1, determines that a media control input is desired from a user. These media controls may enable the user to play, pause, fast forward, rewind, or otherwise control the media content. For example, if the computing device is playing media content such as a movie or video, the computing device may provide a media controls user interface 320 to the user, enabling the user to control the media content.

To do this, the computing device may send a media controls user interface 320 to the remote control device 300 via interface receiver module 350 to enable the user to enter the desired media control input. The user may then select the desired media control input by touching the touch-sensitive display 310 at a location indicative of the desired input (e,g. touch the triangle play button to play the media content). The media controls user interface 320 shown in FIG. 3 illustrates merely one example of media controls and should not be seen as limiting. Other media controls may be used.

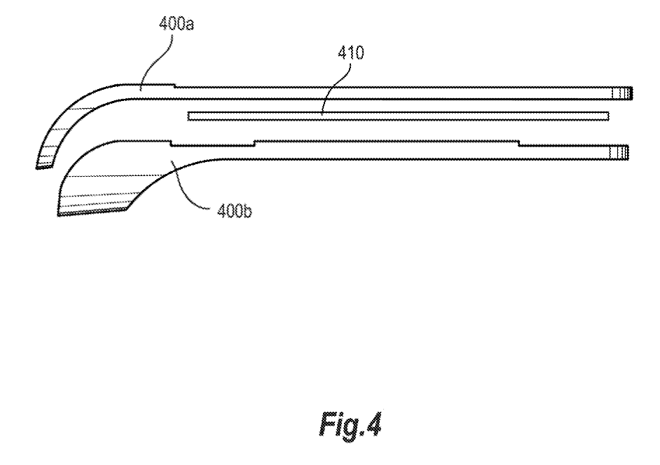

FIG. 4 illustrates a remote control device having a touch-sensitive display 410 enclosed in a housing 400a,b according to examples of the present disclosure. FIG. 4 shows merely one example configuration of a remote control device, and other configurations are possible.

In the example remote control device shown in FIG. 4, the housing 400a,b has an upper housing 400a and a lower housing 400b. The touch-sensitive display 410 may be positioned between the upper housing 400a and the lower housing 400b such that the touch-sensitive display 410 may be entirely enclosed by the housing 400a,b when the housing portions are brought together. In this example, the touch-sensitive display 410 may be manipulated by the user through the upper housing 400a. For example, the upper housing 400a may have a covering over the touch-sensitive display 410 to protect the touch-sensitive display 410 while allowing the user to interact with the touch-sensitive display 410. In another example, the upper housing 400a may include a cut-out portion through which the touch-sensitive display 410 is visible and accessible to the user.

In one example, the remote control device may also include a transceiver (not shown) for sending data to and receiving data from a computing device. Although a single transceiver may be utilized, multiple transceivers, or separate transmitters and receivers, may be used. The transceiver (or transmitter and receiver) enables the remote control device to receive a desired user interface from a computing device for displaying on the touch-sensitive display 410. The data sent to and from the remote control device may be transmitted wirelessly via radio frequency, WiFi, infrared, Bluetooth, or another suitable transmission method.

The remote control device may also include other hardware. For example, the remote control device may include a battery or other power source. The remote control device may also include a processor or a memory for storing instructions executed by the processor or on any other type of volatile or non-volatile memory that stores instructions to cause a programmable processor to perform the techniques described herein. Alternatively or additionally, the example computing system 100 may include dedicated hardware, such as one or more integrated circuits. Application Specific integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

In one example, the remote control device may include a memory for storing the user interface received from the computing device. Additionally, the memory may store a number of interfaces for displaying. The computing device may send a signal to the remote control device to cause one or more of the stored interfaces to be displayed. The remote control device may also include a port or multiple ports, such as for charging the remote control device or for connecting the remote control device to a computing device for charging or data communication.

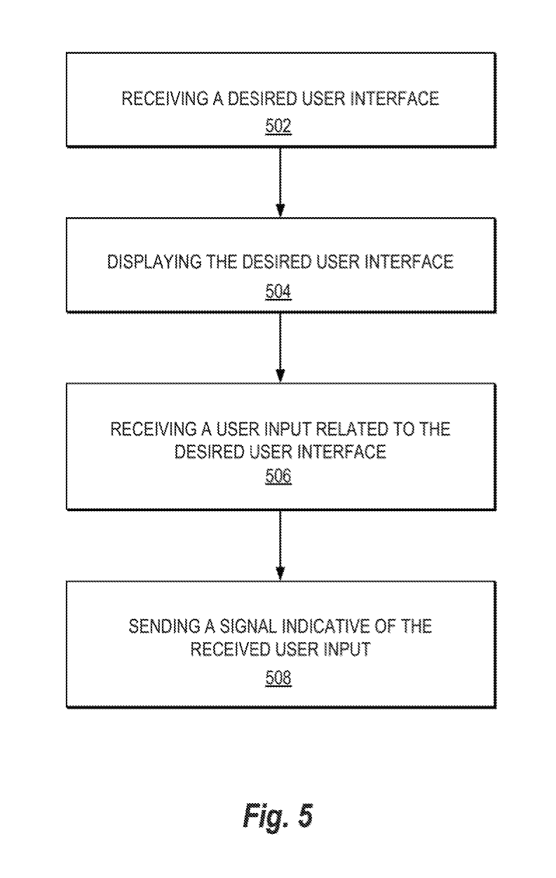

FIG. 5 illustrates a method 500 for displaying a user interface received from a computing device on an interface device having a touch-sensitive display according to examples of the present disclosure. The method 500 may be performed by the remote control device 100 of FIG. 1, for example, or on another suitable device. The method 500 may include: receiving, on an interface device, a desired user interface from a computing device (block 502); displaying, on a touch-sensitive display of an interface device, the received desired user interface (block 504); receiving, on the touch-sensitive display of the interface device, a user input related to the desired user interface (block 506); and sending, by the interface device, a signal to the computing device indicative of the received user input (block 508). Additional processes also may be included, and it should be understood that the processes depicted in FIG. 5 represent generalized illustrations, and that other processes may be added or existing processes may be removed, modified, or rearranged without departing from the scope and spirit of the present disclosure.

At block 502, the interface device receives a desired user interface from a computing device. For example, as a user interacts with the computing device, the computing device determines the desired user interface to display to the user based on the user's action (or desired user input type). The interface device then receives the desired user interface from the computing device. For example, if the computing device is playing a movie or video on the computing device's display, the computing device may determine to cause a media control interface to be displayed on the interface device.

After the interface device receives the desired user interface from the computing device at block 502, the touch-sensitive display of the interface device displays the desired user interface to the user at block 504. For example, if the computing device is playing a movie or video on the computing device's display, a media control interface may be displayed on the interface device.

At block 506, the touch-sensitive display of the interface device receives a user input related to the desired user interface. For example, if the computing device is playing a movie or video on the interface device, the user may wish to pause the movie or video. To do so, the user may press or select the “pause” button displayed on the touch-sensitive display of the interface device.

At block 508, the interface device sends a signal to the computing device indicative of the user input received at block 506. For example, if the user has pressed the “pause” button displayed on the touch-sensitive display of the interface device, the interface device may send the pause command to the computing device. This may cause the computing device to pause the movie or video.

It should be emphasized that the above-described embodiments are merely possible examples of implementations, set forth for a dear understanding of the principles of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
receiving, on an interface receiver module of an interface device, a desired user interface from a computing device, wherein the desired user interface is determined by the computing device based on a desired user input type;
displaying, on a touch-sensitive display of the interface: device, the received desired user interface;
receiving, on the touch-sensitive display of the interface device, a user input related to the desired user interface; and
sending, by the interface device, a signal to the con outing device indicative of the received user input.

2. The method of claim 1, wherein h desired user interface is a keyboard.

3. The method of claim 1, wherein the desired user interface is a set of media controls.

4. The method of claim 1, wherein h desired user interface is a touch pad.

5. The method of claim 4, wherein the touch supports gestures.

6. The method of claim 1, further comprising:
receiving, on the interface receiver module of the interface device, a second desired user interface from the computing device.

7. The method of claim 6, further comprising:
displaying, on the touch-sensitive display of the user interface device, the received second desired user interface.

8. The method of claim 7 further comprising:
displaying, on the touch-sensitive display of the user interface device, the received desired user interface and the received second desired user interface at the same time.

9. A remote control device comprising:
a touch-sensitive display to display a user interface and to receive an input from a user, wherein the user interlace is determined by and received from a computing device;
an interface receiver module to send data to and receive the user interface from the computing device; and
a housing containing the touch-sensitive display and the transceiver module.

10. The remote control device of claim 9, wherein the user interface is a keyboard.

11. The remote control device of claim 9, wherein the user interface is a set of media controls.

12. The remote control device of claim 9, wherein the user interface is a touch pad.

13. The remote control device of claim 12, wherein the touch pad supports gestures.

14. A system comprising:
a computing device having a display to display content; and
a remote control device having a touch-sensitive display to display a user interface determined by the computing device based on the content displayed on the display of the computing device, the user interface being received by the remote control device from the computing device.

15. The system of claim 14, wherein the use interface is received by the remote control device via an interface receiver module of the remote control device.
